(19) United States
(12) Patent Application Publication
(10) Pub. No.: US 2009/0144556 A1
(43) Pub. Date: Jun. 4, 2009

(54) GENERIC ELECTRONIC KEY PROVIDED WITH A CUSTOMIZED SMART CARD

(75) Inventors: Eric Plet, Saint Zacharie (FR); Max De Groot, La Bouilladisse (FR)

Correspondence Address: BUCHANAN, INGERSOLL & ROONEY PC, POST OFFICE BOX 1404, ALEXANDRIA, VA, 22313-1404, US

(73) Assignee: GEMPLUS, GEMENOS (FR)

(21) Appl. No.: 12/097,333

(22) PCT Filed: Dec. 18, 2006
(86) PCT No.: PCT/EP06/69870

§ 371 Date: Jun. 13, 2008

(30) Foreign Application Priority Data
Jan. 6, 2006 (FR) 0650055

(51) Int. Cl. H04L 9/00; G06F 3/048; G06F 1/26; H01R 43/00

(52) U.S. Cl. 713/185; 713/300; 719/312; 715/781; 29/592.1; 719/321

(57) ABSTRACT

A portable electronic device has a case including: a smart chip, an application which is stored in the smart chip, at least one interface for a user, and a microcontroller which controls the smart chip and the interface. The aforementioned microcontroller is configured to execute the primitive functions of the electronic key in order for the interface to be used, while the smart chip is configured to execute the application. The application is configured to generate calls to the primitive functions in order to communicate with the user by means of the interface.

The present invention relates to a portable electronic device such as an electronic key comprising, in the same case, a smart chip storing an application, a user interface and a microcontroller controlling this interface and the chip.

In the IT industry, electronic key refers to a portable hardware device which can be connected to a computer and act, for example, as an authentication key for a software program. The use of such keys, commonly known as tokens or dongles is known for various applications: generation of a One-Time Password (OTP) during network authentication in a computer system, management of software user rights, signing and encryption of electronic documents, authentication of subscribers in a mobile telephony system using the EAP-SIM protocol (Extensible Authentication Protocol Method for GSM Subscriber Identity), securitisation and encryption of information transport within computer networks (TLS: Transport Layer Security). Such electronic keys can be used in stand-alone mode and/or connected to a host machine by a USB interface (Universal Serial Bus), for example.

This type of electronic key is known, for example from patent and patent application US 2005/0109841 (Ryan et al.) and U.S. Pat. No. 5,937,068 (Audebert) in which a first part (“smart fob” and “personal computer”) similar to the microcontroller controls a chip card and directly carries out processes (increasing counters, concatenation operations) to implement the application for which the key is designed.

In general terms, electronic keys of the prior art rely on the microcontroller controlling the secured chip by means of a suitable microprogram. As an example, FIG. 1 shows the operation of a stand-alone electronic key equipped with a power and selection button and a screen for generating a one-time password. Successively, the user activates (10) the electronic key by pressing the button and then the microprogram requests the display (12) on the screen of a menu of the application offering several options to the user. The user's choice, made using the selection button, is detected (14) allowing the execution of the chosen application (16). In the case of a one-time password request, the microcontroller powers the smart chip (18), emits a request to the smart chip with the parameters which can be used to generate the password (20), then the smart chip generates an OTP (22), which it transmits to the microcontroller (24). The latter switches off the smart chip (26), displays the received OTP on the screen of the key (28) for a defined time, and then the electronic key (30) switches off.

In these electronic keys, the application program embedded in the smart chip performs processes to generate data that are useful for the user. The operation described above also requires a microprogram that can manage, in addition to the interfaces of the key (screen, selection button, etc.), the execution of the smart chip application. The latter application is specific to the use intended for the key, so that the microprogram is also.

In this way, electronic keys performing different functions require the development of different main applications for smart chips as well as different associated control programs.

The development of control microprograms is limiting in that the development of programs for smart chips is mastered at the coding level (Java, C++, etc.) and at the process (design, development, validation) or industrialisation levels (testing and starting, personalisation) and in that the environment of the microprograms is confidential, only known to specialists.

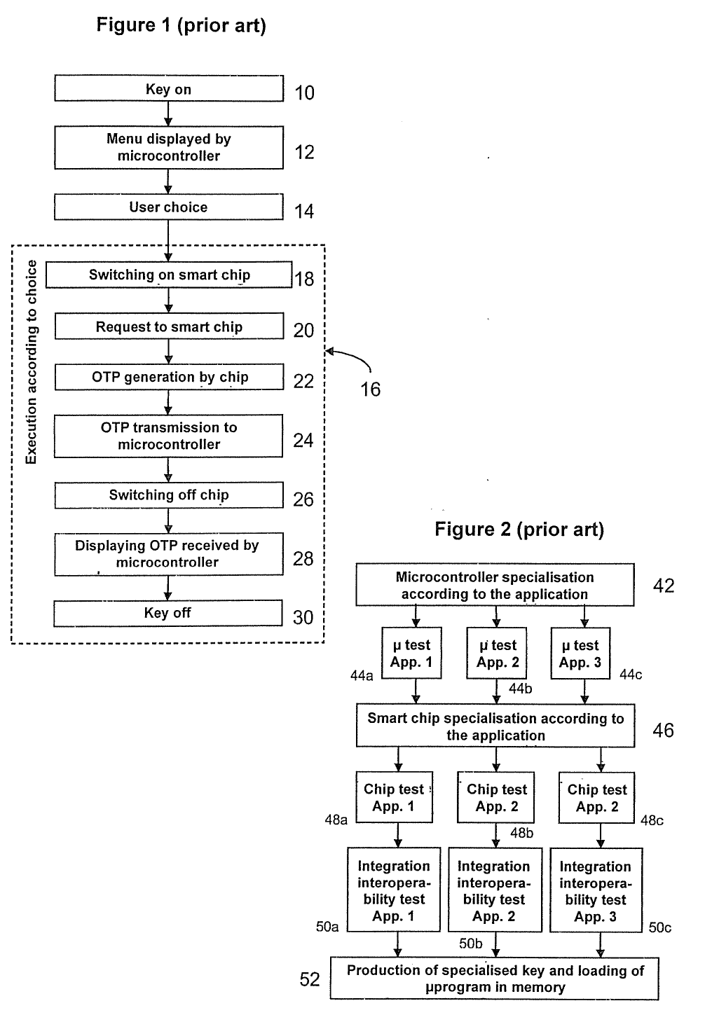

A second disadvantage relating to the need to have a specific microprogram and a specific main application relates to the need to provide an increased number of testing and validation phases, involving additional costs and device requisition. This disadvantage is illustrated in FIG. 2, which shows various steps in the process of manufacturing a personalised electronic key. When designing the key, a microprogram (42) dedicated to the intended application is developed and requires different validation tests according to whether the intended application is no. 1 (44a), no. 2 (44b) or no. 3 (44c). Then, the smart chip is personalised with the desired main application (46) and validation tests are performed (48a, 48b, 48c). This is followed by tests to confirm the interoperability and integration of the microprogram with the main application (50a, 50b, 50c). These tests vary according to the intended application. Then, during the physical production of the keys, which consists of assembling different components of the key, the microprogram is loaded in memory for the microcontroller, generally during a very early stage of key production (52).

A third disadvantage of the electronic keys of the prior art relates to the considerable increase in production costs when the number of keys to be produced is increased and/or new key applications are implemented. These solutions of the prior art do not maximise the possibilities of sharing the costs involved in producing keys and purchasing components. As previously mentioned, the keys are specialised in a very early stage of production, requiring specific production for each application, specific management of stock per application, etc.

A partial solution to this disadvantage is known as shown in FIG. 2. This solution relies on loading the specific microprogram in a memory of the microcontroller during the personalisation operation, allowing a generic electronic key to be used before personalisation for different intended uses. However, this partial solution requires an electronic key having a computer interface with a third-party device for the purpose of personalising the microcontroller. This solution is therefore not applicable to stand-alone electronic keys.

Another disadvantage of these electronic keys relates to the memory in which the specific microprogram is loaded. Indeed, due to the previously described step (52), this memory is necessarily of the programmable type (EEPROM—Electrically Erasable and Programmable Read-Only Memory, Flash, etc.) which implies an additional cost compared with read-only memories with the same capacity, such as ROM. In addition, these programmable memories require more wiring as it is necessary to connect more tracks from the memory component to the microcontroller. In addition, it should be noted that this memory is rarely secured, unlike that of the smart chip, leaving the entire application open to hacker attacks.

The present invention aims to solve at least one of these disadvantages by providing a solution in which the microprogram (microcontroller) remains generic regardless of the intended application and only the smart chip is personalised, the smart chip therefore controlling the microcontroller to implement the desired application. In this design, the microprogram offers the main application of the smart chip a series of standard functions relating to the basic functions of the electronic key. The main application of the smart chip implements the desired application by means of its standard functions. This ensures reduced specialisation of the electronic key and straightforward development of the microprogram independently from the application of the smart chip.

The main application, for example a one-time password generator, is stored and executed by the single smart-chip component, for example a chip card. The microcontroller is used to initialise the execution of the main application and to supply this application with the basic functions of the electronic key, such as display, management of selection interfaces with the user, clock management, etc.

In this way, the present invention makes it possible to rationalise and reduce electronic key production costs: only one generic electronic key is required for various applications. Only the smart chip is personalised.

It addition, it allows a reduction of development costs since only the main application and the associated tests are now required. This main application must nevertheless provide management of the electronic key as it now controls the device. This development-related constraint is compensated by the fact that the development of chip-card applications has now been mostly mastered.

Another advantage of the present invention lies in the possibility of dynamically modifying the smart chip and thus offering the possibility of correcting a bug or providing new functions using the same key.

For this purpose, the present invention relates above all to a portable electronic device, such as an electronic key comprising a case, said case comprising a smart chip, an application stored in the smart chip, at least one interface with a user and a microcontroller controlling said smart chip and said interface, said microcontroller being designed to execute primitive functions of said electronic key in order for said interface to be used and said smart chip being designed to execute said application, the latter being designed to generate calls to the primitive functions in order to communicate with the user by means of said interface.

The interface with the user allows the application to supply information (password, for example) or recover data from the user (selection of a menu from among a list, confirmation of an action, etc.). Such an interface includes, in particular and in a non-exhaustive fashion, a display screen (password, list of menus, confirmation instruction, etc.), an on/off button used for stand-alone keys, a selection button allowing navigation among the various items in a menu, a confirmation button for confirming a selection or the data displayed, etc.

A smart chip should be thought of as an integrated circuit having stand-alone processing resources providing them with great security: microprocessor, memories, etc. These smart chips are used in the production of chip cards. In the present invention, the smart chip can be in the form of a chip-card module connected to a chip-card reader, either directly soldered to the electric circuit supporting the microcontroller, or in a removable form using a specialised connector. The use of a chip-card reader can be necessary if required by the microcontroller.

The primitive functions include all the generic/basic functions of the electronic key. These are therefore functions provided by the generic electronic key regardless of the intended application, which is stored in the secured chip. These are essentially functions of controlling the display screen, managing the clock, initialising the microcontroller, controlling a communication interface (USB, MMC—Multimedia Card) with a third-party device, when provided, sending instructions or commands to the smart chip, etc.

The application in the chip is specific to the desired use, for example OTP calculations, cryptographic calculations, etc.

Furthermore, a master-slave relationship exists between the smart chip and the microcontroller, said smart chip supplying said microcontroller with execution instructions comprising said calls to the primitive functions and, possibly, calls to functions of the actual smart chip. In order to optimise development costs, it may suit to reuse confirmed and certified applications inside the smart chip and to complete this initial application with one or several complementary applications providing additional functions according to the desired use of the key. The applications are then made to communicate with one another by means of calls to the functions of the actual chip.

Since only the application in the chip is personalised according to the desired use, this is the application that can control the sequencing of the processing steps. In this way, the chip becomes the master of the device, unlike the electronic keys of the prior art. The microcontroller then initiates the execution of the main application by the secured chip by means of controlling the input power of this chip and by means of a generic request whose interpretation as an initialisation request must have been integrated in the chip functions. This is why the microcontroller can interrogate said chip at the time of initialisation and by standard control to receive said execution instructions.

The microcontroller is then controlled by the chip by sending messages comprising the instructions for controlling the microcontroller, these instructions having a syntax format that can be interpreted by the microcontroller and including calls to the primitive functions and, possibly, calls to the functions of the smart chip, allowing an interaction with the user.

Furthermore, when the chip transmits a plurality of instructions to the microcontroller, which the latter must execute, it is desirable to memorise these instructions and execute them gradually. In this embodiment, said case of the electronic key also comprises a memory connected to said microcontroller, and said microcontroller is configured to store said instructions comprising calls to the primitive functions in said memory.

According to one embodiment, said interface is a display screen and comprises, in addition, a user interface for “selection”.

Furthermore, the electronic key can be used for applications in a mode connected with a host system, such as a personal computer. For this purpose, the electronic key comprises, in addition, an interface for communicating with a third-party electronic device and said microcontroller is configured to transfer data emitted by said third-party device to said chip and data emitted by the chip to said third-party device. In the exchanges between the chip and the third-party device, the microcontroller plays the role of a relay transmitting the data emitted from one component to the other.

This communication interface can be a USB or USB2 port, an MMC interface, a wireless communication interface such as Bluetooth, IRDA (Infrared Data Association), RFID (Radio Frequency Identification) according to ISO 14443 or RFID according to ISO 15693, for example.

Furthermore, the electronic keys of the prior art cannot be tested until they have been personalised. Said application is then seen to be a generic program for testing primitive functions of said microcontroller, this program being present in the generic electronic key prior to personalisation. This test program can be executed during the generic key production steps in order to confirm the “generic” operation of this key.

In particular, said chip comprises a second application configured to generate calls to the primitive functions and to perform algorithmic processes, and means configured to deactivate said generic test program. The second application, which is to say the main application intended for the electronic key, takes over from the test application using the deactivation means. Then, the initialisation launched by the microcontroller launches the main application.

In one embodiment, said application is a program for generating one-time passwords.

The invention also relates to the application of the electronic key to the generation and transmission of single-use authentication data.

Transmission is understood to mean the act of sending authentication data to a third-party device using suitable communication means (such as listed above) or to a user by means of the display screen.

The invention also relates to a method of manufacturing a personalised portable electronic device, such as an electronic key, comprising:
a step of manufacturing a generic portable device comprising a case, the latter comprising a smart chip, at least one interface with a user and a microcontroller controlling said smart chip and said interface, said microcontroller being configured to execute the primitive functions of said portable electronic device in order for said interface to be used and said smart chip being configured to execute said application, the latter being configured to generate calls to the primitive functions in order to communicate with the user by means of said interface,
a step of personalising said smart chip by storing a second application configured to generate calls to the primitive functions.

According to one embodiment, said application stored in the chip of the generic key is a generic test program generating calls to the primitive functions, and the method comprises, after said manufacturing step, a step of testing said electronic key consisting of executing the generic test program.

The invention also relates to a method of using a portable electronic device, for example an electronic key, such as previously described, the method comprising one or more exchanges defined by:
a step of said microcontroller sending a request to said smart chip to obtain instructions to execute,
upon receiving said request, a step of said smart chip transmitting a script containing at least one instruction calling said primitive functions directed to said microcontroller,
a step of said microcontroller executing said script.

The request can be a request for initialisation when the key starts up, in order to launch the main application of the chip, or a result (user input) in which case the transmission of the result to the chip constitutes an implicit request, since this message implies that the microcontroller is awaiting the next instruction to execute.

According to one embodiment, the method also comprises a step of storing said script in a memory, the storage being carried out by the microcontroller upon receiving the script, and said step of executing the script consists of reading each instruction of the script in memory and executing the instruction after reading.

According to one alternative, the method also comprises a plurality of transmissions of requests from the microcontroller to said smart chip and, in response to each of these transmissions, a step of said microcontroller receiving at least one instruction emitted by the smart chip and the microcontroller executing said instruction. In this case, the requests can be “standard requests” characterised in that they are independent from the application in the smart chip's memory, since they aim to obtain the specific instructions of an application from a generic microcontroller. These requests can also comprise data specific to the application of the portable device, in which case these data are supplied by the user by means of the interface (for example, choosing an item from a menu) and transmitted to the chip without modification or interpretation by the microcontroller (since the latter is not specific to the target application).

According to an alternative embodiment which aims to optimise the power consumption of the smart chip, in particular for stand-alone electronic keys, the method comprises, during the execution of a script or an instruction, a prior step of powering the smart chip by the microcontroller and a subsequent step, after at least one exchange with the smart chip, of the microcontroller switching the smart chip off. The information for executing these two prior and subsequent steps can be specified in the actual script or the actual instruction.

The invention will also be understood better with the help of the drawings, wherein:

FIG. 1 shows the operation of a stand-alone electronic key of the prior art equipped with a power and selection button and a screen for generating a one-time password;

FIG. 2 shows an example of the process of manufacturing a personalised electronic key of the prior art;

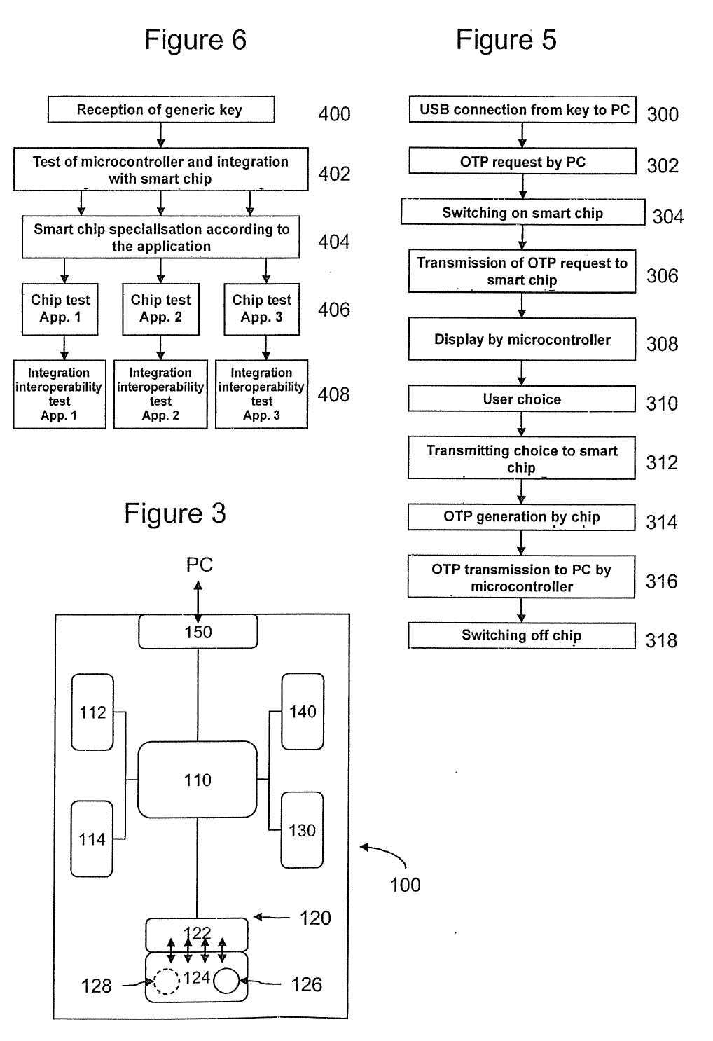

FIG. 3 shows an example of the architecture of an electronic key according to the present invention;

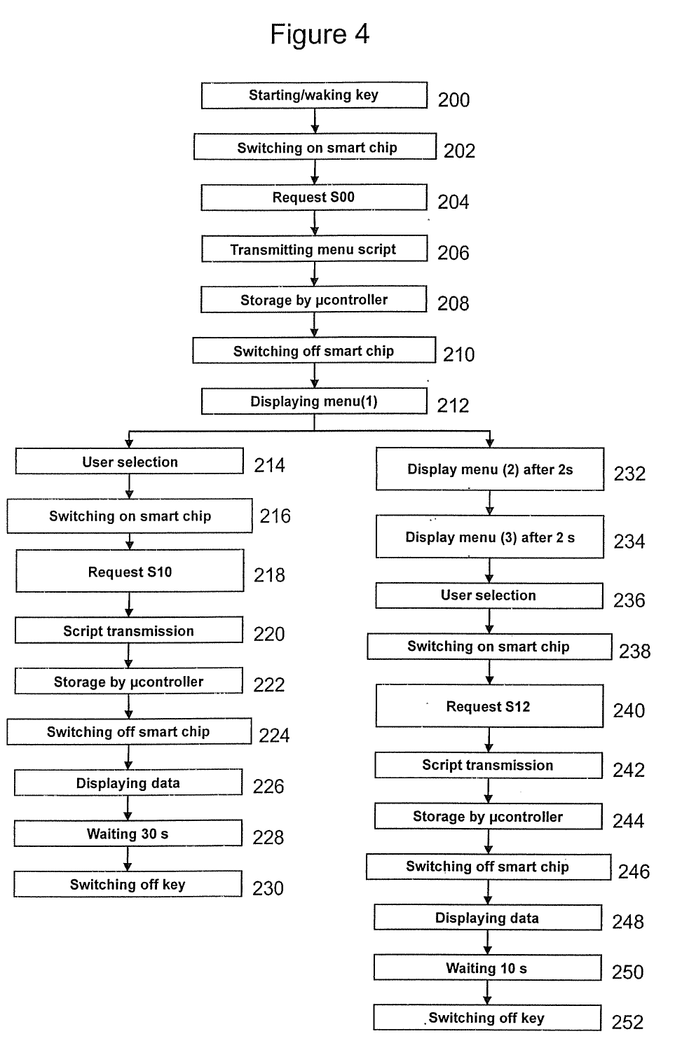

FIG. 4 shows the operation of an electronic key according to the present invention;

FIG. 5 shows another example of the operation of an electronic key according to the present invention, where this operation can be combined with that shown in FIG. 3 in the same electronic key; and

FIG. 6 shows an example of a manufacturing process of a personalised electronic key according to the present invention.

In reference to FIG. 3, an electronic key 100 used to generate one-time passwords OTP according to the present invention comprises:
a microcontroller 110 equipped with a read-only memory ROM 112 containing the microprogram for executing the microcontroller and a random-access memory RAM 114 for temporarily storing data during the operation of the key,
the secured smart chip 124 possibly connected via a “chip card” interface component 122 to the microprocessor. The secured chip is of the smart type comprising a microprocessor, RAM and ROM memory and means for communicating with the microcontroller 110 via the interface component 122. The chip comprises in its ROM memory an application program 126 (or main application) dedicated to the desired application of the electronic key (the generation of one-time passwords), this program supplying various processes or functions to be executed (hereinafter, some of these processes are noted S00, S10, etc.). One alternative for such a chip module 120 is described in patent U.S. Pat. No. 6,763,399, wherein the smart chip is directly connected to the microcontroller by means of specific protocol compliant with ISO 7816-3,
a display screen 130 for displaying data or information to the user, connected to the microcontroller,
one or several on/off and/or selection buttons 140 allowing the user either to switch the key on 100 or to select and confirm the options offered by the electronic key by means of the display screen 130. The button or buttons are connected to the microcontroller, the latter using the actions applied to the buttons, and
an interface 150 for connecting with a third-party device, typically a personal computer PC with which the electronic key communicates to generate a one-time password for the user. This communication interface is connected to the microcontroller.

The microprogram of the microcontroller supplies basic or “primitive” functions which act on the generic components of the key 100, including the following:
Menu: this function opens a menu and allows the selection of an item according to a timer which can be configured or specific to the electronic key, for example 2 seconds;
Display: this function displays a chain of characters and can scroll if the chain exceeds the capacity of the screen;
Save: allows the user to save the following instructions in RAM memory 114 before execution;
UWait: this function requests the electronic key to wait and cannot be cancelled;
Wait: this function requests the electronic key to wait but it is possible to move on to the next instruction by pressing the button 140;

Power Off: this function switches the key off.

Application to the Generation of a Password in Stand-Alone Mode

The generation of a one-time password for the user requires several steps as shown in FIG. 4:

200: the user of the key 100 switches the latter on by pressing the button 140. This powers the key and awakens the microcontroller 110;

202: when it wakes up, the microcontroller switches on the smart chip 124;

204: the microcontroller executes a generic instruction which consists of emitting a process request S00 to the chip. This generic instruction can be coded directly in the executable code of the microprogram or stored at a specific location of the read-only memory 12 which the microprocessor accesses by default. This instruction can possibly be stored in a remote server accessible by communication means configured in a suitable manner. This process request S00 invites the chip 124 to execute the process S00 of the application program;

206: when it receives the request S00, the chip 124 executes this process S00, which allows it to transmit an execution script to the microcontroller containing the instructions that the microcontroller must execute. This script is stored at a specific memory location of the chip 124 or directly in the application program 126. The script is a chain of characters comprising calls to the primitive functions available in the microcontroller: “Menu: OTP (S10), Counter (S11), Token ID (S12)”, where the values S10, S11 and S12 correspond to identifiers of processes used by the smart chip to interpret the user's selection.

In one embodiment, the request S00 emitted by the microcontroller corresponds to the signal to switch on the smart chip (electric power). The latter is configured to answer when it is initialised (ATR—Answer To Reset) by sending an ATR sequence containing predefined so-called “historical” bytes which contain the script;

208: upon receiving the script, the microcontroller stores the script in the RAM memory 114. This temporary storage is useful, in particular, when several execution instructions are included in the transmitted script. Storage can be carried out automatically by the microcontroller or forced by the chip 124, by adding the primitive function “Save” at the start of the script and allowing the microcontroller to save the set of instructions in the RAM memory 114;

210: the microcontroller switches the chip-card module 120 off;

212: the microprogram executes the instruction “Menu: OTP (S10), Counter (S11), Token ID (S12)” and then displays on the screen 130 the first item of the menu, namely “OTP”, for the programmed duration of 2 seconds;

214: a user wanting to generate an OTP confirms the choice by releasing, for example, the button 140 that had been kept pressed since step 200 when “OTP” is displayed on the screen. The microprogram interprets the user's entry (confirmation) and moves on to the next steps;

216: the microcontroller switches the module 120 back on;

218: the microcontroller emits a request to execute the process S10 directed to the chip 124;

220: the smart chip executes the process S10, which is to say the operations for generating the one-time password, and transmits the script “Display gX36Jz; UWait 30 s; Power Off” to the microcontroller;

222: the latter stores the script in memory 114, in particular because it contains three instructions (Display, UWait and Power Off) to be executed one after another;

224: the microcontroller switches the smart chip off;

226: then the microcontroller executes the script, which is to say the first instruction “Display gX36Jz” and then displays the generated password “gX36Jz” on the screen 130;

228: the microcontroller then executes “UWait 30 s”, freezing the display for 30 seconds without any action by the user being able to modify the behaviour of the key;

230: at the end of the 30 s, the next instruction, “Power Off”, is executed by the microcontroller, causing the key to switch off.

It is foreseeable for the chip only to transmit one instruction at a time, so that the microcontroller queries the card after each instruction executed, allowing dynamic execution based on decisions made by the card.

Also in reference to FIG. 4, in the event that the user wants to recover the electronic key identification number, the display of menu item 1 during step 212 ends after the 2-second timer. The microcontroller then displays (232) item 2 of the “Counter” menu during the timer, the user having the option at any time of releasing the button 140 to access the menu and trigger the execution of the process S11 by the smart chip. If the user does not intervene during the timer, item 3 “Token ID” is then displayed (234), similarly to the manner described above:

236: the user releases the button 140 to confirm the choice of “Token ID”;

238: the microcontroller switches on the chip card;

240: the microcontroller emits a request to execute the process S12 directed to the chip 124;

242: the smart chip executes the process S12, which is to say the recovery and transmission of the electronic key serial number. It then transmits the script “Display N123456; Wait 10 s; Power Off” to the microcontroller;

244: the latter stores the script in memory 114;

246: the microcontroller switches the smart chip off;

248: then the microcontroller executes the script, which is to say the first instruction “Display N123456”, displaying the key identifier “N123456” on the screen 130;

250: the microcontroller then executes “Wait 10 s”, freezing the display for 10 S. If the user presses the button 140, the microcontroller immediately executes the next instruction, namely switching the key off;

252: at the end of the 10 s or if there is any action by the user, the next instruction “Power Off” is executed by the microcontroller, resulting in the key being switched off.

FIG. 5 shows another form of using the key, interacting with a third-party device PC to supply an OTP.

300: the user connects the key 100 to the third-party device by means of a USB port and the interface 150. The key is then automatically powered by the USB interface;

302: the PC emits an OTP request via the USB port;

304: the microcontroller then powers the chip-card module 120; then

306: the microcontroller transmits the OTP request to the module 120 corresponding to a process to be executed by the chip 124;

308: the smart chip emits a display request “Display” to invite the user to confirm the sending of a password;

310: the user confirms the command by pressing the button 140;

312: the confirmation is transmitted by the microcontroller to the chip card;

314: the chip 124 then generates a password OTP and transmits it to the microcontroller; then

316: the latter transmits the OTP to the PC;

318: the microcontroller disconnects the power to the chip-card module.

FIG. 6 shows the various steps performed by a company wanting to personalise an electronic key according to the present invention according to the desired application.

In step 400, the company receives the generic electronic keys. The invention allows the use of only one generic key with the same microprogram regardless of the intended use and the personalisation added, enabling a reduction of the production costs brought about by increasing the volumes and/or the diversification of applications and facilitating the management of key stocks. The microprogram controlling the microcontroller is installed in ROM memory 112 by the component manufacturer. The individual manufacturing costs are thus reduced since ROM memory is inexpensive.

The electronic key, in its generic version, comprises a test program 128 stored in the memory of the secured chip. This test program is generic and makes it possible, when executed by the chip 124, to test the functionalities available to the microcontroller 110;

402: in order to test the key, the user switches the key on. The microcontroller then transmits the request S00 to the chip, this process S00 being associated with the test program in the chip. The latter then emits a test script, for example “Display Test1; UWait 10 s; Display Test2; Wait 5 s; Display 5; UWait 1 s; Display 4; UWait 1 s; Display 3; UWait 1 s; Display 2; UWait 1 s; Display 1; UWait 1 s; Display Extinction; UWait 1 s; Power Off”. The user then confirms the correct operation of the key by checking that it displays “Test1” for 10 seconds, then “Test 2” for 5 seconds and then counts down from 5 to 0 until the key switches off. The test script ideally calls each of the primitive functions of the microcontroller at least once. Such a test phase can be performed at various levels of the production chain.

404: when the test is positive, the company personalises the electronic key according to the intended application. This personalisation step consists of loading the main application 126 (or a series of processes to execute) in the chip 124. This loading can be carried out via the USB communication interface 150 or else by placing the chip 124 in another chip-card reader connected directly to a programming computer. The loading of this main application 126 prevents the application of a test 128, for example by modifying, in the chip-card memory, a register associated with the process S00 which then points to the memory address of the recently loaded application 126;

406 and 408: after personalisation, tests relating to the specific application and its interoperability with the key as a whole are conducted taking this characteristic into account.

The presence of the interface 150 enables, at no noticeable additional cost, subsequent modification of the behaviour of the electronic key (bug correction, application optimisation, etc.)

1. Portable electronic device comprising a case, said case comprising a smart chip, an application stored in the smart chip, at least one user interface and a microcontroller controlling said smart chip and said interface, said microcontroller being configured to execute the primitive functions of said electronic key by exploiting said interface and said smart chip being configured to execute said application, wherein said application is configured to generate calls to the primitive functions in order to communicate with the user by means of said interface.

2. Portable electronic device according to the claim 1, wherein a master-slave relationship exists between the smart chip and the microcontroller, said smart chip supplying the microcontroller with execution instructions comprising said calls to the primitive functions.

3. Portable electronic device according to the claim 2, wherein the microcontroller can interrogate said smart chip during its initialisation and by a standard control in order to receive said execution instructions.

4. Portable electronic device according to claim 2, wherein said case of the electronic key also comprises a memory connected to said microcontroller, and wherein said microcontroller is configured to store in said memory said instructions including the calls to the primitive functions.

5. Portable electronic device according to claim 1, wherein said interface is a display screen and wherein said interface also comprises a user interface for “selection”.

6. Portable electronic device according to claim 1, further comprising an interface for communicating with a third-party electronic device, and wherein said microcontroller is configured to transfer data emitted by said third-party device to said smart chip and data emitted by the smart chip to said third-party device.

7. Portable electronic device according to claim 6, wherein said communication interface comprises one of the following: a USB interface, a USB2 interface, a Bluetooth interface, an IRDA interface, an RFID interface or an MMC interface.

8. Portable electronic device according to claim 1, wherein said application is a generic program for testing the primitive functions of said microcontroller.

9. Portable electronic device according to claim 8, wherein said smart chip comprises a second application configured to generate calls to the primitive functions and to perform algorithmic processes, and means designed to deactivate said generic test program.

10. Portable electronic device according to claim 1, wherein said application is a program for generating one-time passwords.

11. Application of the portable electronic device according to claim 1 to the generation and transmission of single-use authentication data.

12. Method of manufacturing a personalised portable electronic device, comprising:
a step of manufacturing a generic portable electronic device comprising a case, the latter comprising a smart chip, an application stored in the smart chip, at least one user interface and a microcontroller controlling said smart chip and said interface, said microcontroller being configured to execute the primitive functions of said portable electronic device in order for said interface to be used and said smart chip being configured to execute said application, the latter being configured to generate calls to the primitive functions in order to communicate with the user by said interface,
a step of personalising said smart chip by storing a second application configured to generate calls to the primitive functions.

13. Method according to claim 12, wherein said application stored in the generic portable device is a generic test program generating calls to the primitive functions and wherein the method comprises, after said manufacturing step, a step of testing said portable electronic device by executing the generic test program.

14. Method of using a portable electronic device according to claim 1, including at least one exchange phase comprising of:
a step of said microcontroller sending a request to said smart chip to obtain instructions to execute,
upon receiving said request, a step of said smart chip transmitting a script containing at least one instruction calling said primitive functions directed to said microcontroller, and
a step of said microcontroller executing said script.

15. Method of use according to claim 14, further comprising a step of storing said script in a memory, the storage being carried out by the microcontroller upon receiving the script, and wherein said step of executing the script comprises of reading each instruction of the script in memory and executing the instruction after reading.

16. Method of use according to claim 14, further including a plurality of transmissions of requests from the microcontroller to said smart chip and, in response to each of said transmissions, a step of said microcontroller receiving at least one instruction emitted by the smart chip and the microcontroller executing said instruction.

17. Method of use according to claim 14, further comprising when executing a script or an instruction, a prior step of the microcontroller powering the smart chip and a subsequent step, after at least one exchange with the smart chip, of the microcontroller switching the smart chip off.
